(19) United States
(12) Patent Application Publication
(10) Pub. No.: US 2005/0110343 A1
(43) Pub. Date: May 26, 2005

(54) Vehicle brake system with active hydraulic brake force reinforcement

(76) Inventors: Ralph Gronau, Wetter (DE); Ralf Reviol, Dietzenbch-Steinberg (DE); Jurgen Woywod, Morfelden (DE)

Correspondence Address: Robert P Seitter;RatnerPrestia, One Westlakes Berwyn, Suite 301, P O Box 980, Valley Forge, PA, 19482-0980, US

(21) Appl. No.: 10/506,830

(22) PCT Filed: Mar. 10, 2003
(86) PCT No.: PCT/EP03/02431

(30) Foreign Application Priority Data
Mar. 11, 2002 (DE) 10210603.7

(51) Int. Cl. B60T 8/40

(52) U.S. Cl. 303/116.2

(57) ABSTRACT

The present invention relates to a method and a device for controlling a vehicle brake system with active hydraulic brake force boosting. In this method, an active pressure-increasing unit and/or a pressure modulation unit is actuated according to a comparison between a nominal pressure or a nominal vehicle speed or quantities derived therefrom, in particular a nominal vehicle acceleration, and an actual pressure or an actual vehicle speed or quantities derived therefrom, in particular an actual vehicle acceleration.

### TECHNICAL FIELD

The present invention relates to a method for controlling a vehicle brake system with active hydraulic brake force boosting.

The invention likewise relates to a device for controlling a vehicle brake system with active hydraulic brake force boosting, with an actuating unit by means of which the driver can introduce brake pressure into a hydraulic unit, with at least one wheel brake that is connected to the actuating unit by way of the hydraulic unit comprising at least one brake line, with a pump communicating with its suction side with the actuating unit by way of a change-over valve and communicating with its pressure side with the brake line, with an actuatable inlet valve arranged in the brake line, with an actuatable separating valve interposed between the inlet valve and the actuating unit, with an actuatable outlet valve arranged in a return line, with a pressure sensor associated with the actuating unit, with a wheel speed sensor and with a first actuating unit for actuating the pump that introduces pressure into the wheel brakes for active brake force boosting when a point of maximum boosting of the brake booster is reached or exceeded.

### BACKGROUND OF THE INVENTION

Vacuum brake boosters require a vacuum supply provided by the engine in order to support the pedal force to be generated by the driver. Vacuum supply for brake force boosting is provided more rarely in novel engine technology such as direct injection engines or Diesel engines. Depending on the engine, it is possible already with relatively low pedal forces to reach a condition where further increase of the force applied to the actuating unit is possible only by an increase of the pedal force because the vacuum brake booster has reached the maximum possible boosting force. This condition is referred to as the point of maximum boosting of the booster. Additional auxiliary energy becomes necessary thereafter in order to assist the driver in the braking operation. One possibility of additional brake force boosting is realized in brake systems with active hydraulic brake force boosting wherein a pressure-increasing unit produces an additional hydraulic pressure.

Braking operations which are or shall be executed at low actuating speed that is only slightly in excess of the point of maximum boosting, corresponding e.g. to a pressure in the brake system (brake pressure) of 20 to 30, place high demands on the regulation or control of additional brake force boosting. This is because even minor changes of the pedal force should cause corresponding changes of the brake pressure or the vehicle deceleration in order to impart a comfortable and reliable feel for the brake pedal to the driver.

Systems with additional hydraulic brake force boosting referred to hereinabove which operate with valves for pressure control and pumps for pressure generation suffer from a system-inherent problem of realizing analog brake force boosting because there is only a stepwise pressure increase due to valve switching operations or pump operations. The driver will notice this stepwise increase as it is different from the usual pedal feel.

### BRIEF SUMMARY OF THE INVENTION

In view of the above, an object of the invention is to overcome the shortcomings of hydraulic brake force boosting and provide a reliable brake force adjustment. It is desired that even relatively insignificant changes of the driver's pedal force will cause corresponding changes of the brake pressure or the vehicle deceleration.

This object is achieved by the features of claim 1 and claim 14.

The invention according to claim 1 implements in a method of the type mentioned hereinabove that an active pressure-increasing unit and/or a pressure modulation unit is actuated according to a comparison of a nominal pressure or a nominal vehicle speed or quantities derived therefrom, in particular a nominal vehicle acceleration, with an actual pressure or an actual vehicle speed or quantities derived therefrom, in particular an actual vehicle acceleration.

At least part of the brake assistance provided by the pressure-increasing unit can be produced actively in a brake system of this type with ‘active’ hydraulic brake force boosting. Preferably, a pump provided in the brake system, in particular an hydraulic pump already provided in brake systems with an anti-lock system (ABS) or a driving dynamics control system (ESP system) is used for active brake force boosting.

The term ‘nominal pressure’ refers to brake pressure, which is expected under the given system conditions due to the force or pressure the driver applies to the brake pedal. By way of a vacuum brake booster and a tandem master brake cylinder, the driver's force is converted into hydraulic pressure in this system that is measured at the outlet of the tandem master cylinder by means of pressure sensors. When, in the present system with active hydraulic brake force boosting, the point of maximum boosting of the vacuum brake booster is reached and when the driver continues to apply the brake pedal, the hydraulic pressure-increasing unit—in lack of sufficient assistance by the vacuum brake booster—will further increase the pressure in order to provide the driver with the desired brake power. More specifically, the nominal pressure corresponds to a correcting variable for adjusting the pressure by means of the pressure-increasing unit in conformity with the driver's specification. From the nominal pressure results an expected nominal vehicle speed or nominal vehicle acceleration because a defined rate of brake power acting upon the vehicle is achieved by means of a defined hydraulic pressure in the brake system.

The term ‘vehicle acceleration’ has a very broad meaning herein. In particular, it implies a positive acceleration as well as a negative acceleration, a vehicle deceleration. Pressure increase is generally connected to a reduction of the vehicle acceleration or an increase of the negative acceleration (high rate of deceleration). In contrast thereto, pressure reduction generally leads to an increase in the vehicle acceleration or a reduction of the negative vehicle acceleration (lower rate of deceleration).

In contrast to the hydraulic pressure-increasing unit, the pressure cannot be increased actively by means of the ‘pressure modulation unit’. Said unit is rather used to specifically adjust the hydraulic pressure prevailing at the pressure modulation unit and, more particularly, for pressure reduction.

An analogized electromagnetic valve is preferably used as a pressure modulation unit. Corresponding actuation induces said valve to adopt also intermediate positions between a (fully) open position and a (completely) closed position, with the result that it can adjust a defined pressure gradient between the two sides of the valve at least in approximation.

The term ‘actual pressure’ means the pressure that is actually prevailing at the wheel brakes. Said pressure can be determined by pressure sensors or estimated by way of a model. The result of the virtual actual pressure is a virtual actual vehicle speed or actual vehicle acceleration because a defined brake power that acts on the vehicle is achieved by means of a defined hydraulic pressure in the brake system. The actual vehicle acceleration can e.g. be determined directly by a longitudinal acceleration sensor. The actual pressure or the actual vehicle acceleration, however, is determined preferably from the wheel speeds sensed by means of wheel speed sensors. Preferably, the nominal pressure or the nominal deceleration is calculated from the tandem master cylinder pressure.

The method of the invention allows a reliable adjustment of the pressure or the vehicle acceleration even when it is cold or when there are unfavorable manufacturing tolerances. This is because the hydraulic efficiency of the system is ensured this way. This means that relatively low variations of the driver's pedal force cause a corresponding change of the brake pressure or the vehicle deceleration even at low temperatures. The flow of the hydraulic pressure medium in the direction of the preferred throughflow is increased by comparing the nominal and actual values and by corresponding actuations of the individual components in response to the comparison. This allows minimizing or compensating the influence of any effects that reduce the hydraulic efficiency, such as low temperatures.

It is provided according to the invention that the pressure-increasing unit is actuated for brake pressure increase purposes, the nominal pressure is compared to an actual pressure or the nominal vehicle acceleration is compared to an actual vehicle acceleration, and that when the nominal pressure exceeds the actual pressure or when the nominal vehicle acceleration is lower than the actual vehicle acceleration, the pressure-increasing unit is actuated to generate additional pressure.

More specifically, brake pressure prevailing in the system is additionally increased by means of the hydraulic pressure-increasing unit in the case of too low brake pressure (nominal pressure exceeds actual pressure) or too high an actual vehicle acceleration or too low an actual vehicle deceleration.

It is arranged for by the invention that the pressure-increasing unit is actuated to produce an additional pressure when the nominal pressure is higher than the actual pressure or the nominal vehicle acceleration is lower than the actual vehicle acceleration for a predetermined period of time, preferably 50 to 100 msec or after five to ten actuations of the pressure-increasing unit.

In order to produce additional pressure or to produce an additional negative vehicle acceleration, it is provided by the invention that the pressure-increasing unit extends the pump actuation time by 30% to 100%, preferably by about 50%, with respect to the original pump actuation time when the nominal pressure is higher than the actual pressure or the nominal vehicle acceleration is lower than the actual vehicle acceleration.

The term ‘original’ pump actuation time refers to the time during which the pump was actuated before the situation of the deviation of the nominal pressure from the actual pressure or the nominal vehicle acceleration from the actual vehicle acceleration was detected.

According to the invention, the pressure-increasing unit is actuated to generate additional pressure when the nominal pressure is higher than the actual pressure by at least 20% to 50%, preferably roughly 30% with respect to the nominal pressure, or when the nominal vehicle acceleration is lower than the actual vehicle acceleration by at least 40% to 60%, preferably by roughly 50%, with respect to the nominal vehicle acceleration.

It is arranged for by the invention that the pressure-increasing unit for producing an additional pressure or for producing an additional negative vehicle acceleration extends the pump actuation time by 200% to 400%, preferably by roughly 200%, with respect to the original pump actuation time when the condition that the nominal pressure is higher than the actual pressure or the nominal vehicle acceleration is lower than the actual vehicle acceleration was detected several times in succession, preferably at least two times.

It is provided by the invention that when the pressure modulation unit, like an hydraulic valve, preferably an analogized valve, is actuated to produce an additional pressure reduction, the nominal pressure is compared with an actual pressure or the nominal vehicle acceleration is compared with an actual vehicle acceleration, and that the pressure modulation unit is actuated to produce an additional pressure reduction when the nominal pressure is lower than the actual pressure or when the nominal vehicle acceleration is higher than the actual vehicle acceleration.

It is provided according to the invention that the pressure modulation unit is actuated to produce an additional pressure reduction when the nominal pressure is lower than the actual pressure or the nominal vehicle acceleration is higher than the actual vehicle acceleration for a predefined period of time, preferably 50 to 100 msec or after five to ten actuations of the pressure modulation unit.

According to the invention, the pressure modulation unit, like an hydraulic valve, preferably an analogized valve, for producing an additional pressure reduction, increases the valve actuation current strength by 30% to 100%, preferably roughly 50%, with respect to the original valve actuation current strength when the nominal pressure is lower than the actual pressure or when the nominal vehicle acceleration is higher than the actual vehicle acceleration.

The term ‘original’ valve actuation current strength represents the actuation current strength used to actuate the valve before the situation of the deviation of the nominal pressure from the actual pressure or the nominal vehicle acceleration from the actual vehicle acceleration was detected. The ‘actuation current strength’ herein is a differential current strength.

This means the valve is actuated by a ‘differential current’ (dI) in addition to the principally applied control current for an initial position of the valve. In a case of additional pressure reduction, the hydraulic passage of the valve is increased by means of increasing the differential current.

It is provided by the invention that the pressure modulation unit, like an hydraulic valve, preferably an analogized valve, is actuated to produce an additional pressure reduction, when the nominal pressure is lower than the actual pressure by at least 20% to 50%, preferably by roughly 30%, or when the nominal vehicle acceleration is higher than the actual vehicle acceleration by at least 40% to 60%, preferably by roughly 50% with respect to the nominal vehicle acceleration.

According to the invention, the pressure modulation unit, like an hydraulic valve, preferably an analogized valve, for producing an additional pressure reduction, increases the valve actuation current strength by 200% to 400%, preferably by roughly 200%, with respect to the original valve actuation current strength when the condition that the nominal pressure is lower than the actual pressure or the nominal vehicle acceleration is higher than the actual vehicle acceleration was detected several times in succession, preferably at least two times.

According to the invention, a modified actuation of the pressure-generating unit and/or the pressure modulation unit is memorized for an ignition cycle, that means until the ignition of the vehicle is switched off.

The method is preferably part of a program of an electronic brake control unit for the vehicle brake system and is used to monitor the system at the software end. The detection of a deviation of the nominal pressure from the actual pressure or the nominal vehicle acceleration from the actual vehicle acceleration takes place during each ignition cycle. When a deviation of the actual values from the nominal values is detected within defined limits, the pressure is additionally raised during a pressure increase phase or additionally lowered during a pressure reduction phase according to the method described hereinabove. When a deviation is subsequently detected once again within defined limits, that means at least two times in total, the pressure will be additionally raised during a pressure increase phase or additionally lowered during a pressure reduction phase at a correspondingly higher rate. The operation runs are counted by incrementing an actuation counter when the actual vehicle deceleration or the actual pressure differs from the nominal values within defined limits.

According to the invention, the changes in the actuation of the pump or the valve during a braking operation will only occur when three to ten program runs have taken place or after expiry of a period of 50 to 100 msec or when five to ten actuations of the pump or the valve have already been executed. It is especially preferred that the actuation takes place only when at least five to ten actuations of the pump or the separating valve have taken place. This ensures that a change of the actuation for the pressure increase or the pressure reduction according to the invention is performed only when an acceptable change of the monitored quantity has been adjusted.

Further, this object is achieved according to claim 14 by means of a generic device which is characterized by a first determining unit for determining a nominal pressure or a nominal vehicle acceleration that corresponds to the pressure according to the pressure sensor signal, a second determining unit for determining an actual vehicle acceleration or an actual pressure that corresponds to the vehicle acceleration according to the wheel speed sensor signal, a comparison unit for comparing the nominal pressure with the actual pressure or the actual vehicle acceleration with the nominal vehicle acceleration, a second evaluating unit for actuating the pump or the separating valve according to the comparison, wherein when the nominal pressure is higher than the actual pressure or when the nominal vehicle acceleration is lower than the actual vehicle acceleration, the pump is actuated for the purpose of generating an additional pressure, and when the nominal pressure is lower than the actual pressure or when the nominal vehicle acceleration is higher than the actual vehicle acceleration, the separating valve is actuated for producing an additional pressure reduction.

### BRIEF DESCRIPTION OF THE DRAWINGS

FIG. 1 shows a device according to the invention.

FIG. 2 is a flow chart schematically showing the method of the invention.

### DETAILED DESCRIPTION OF THE PREFERRED EMBODIMENTS

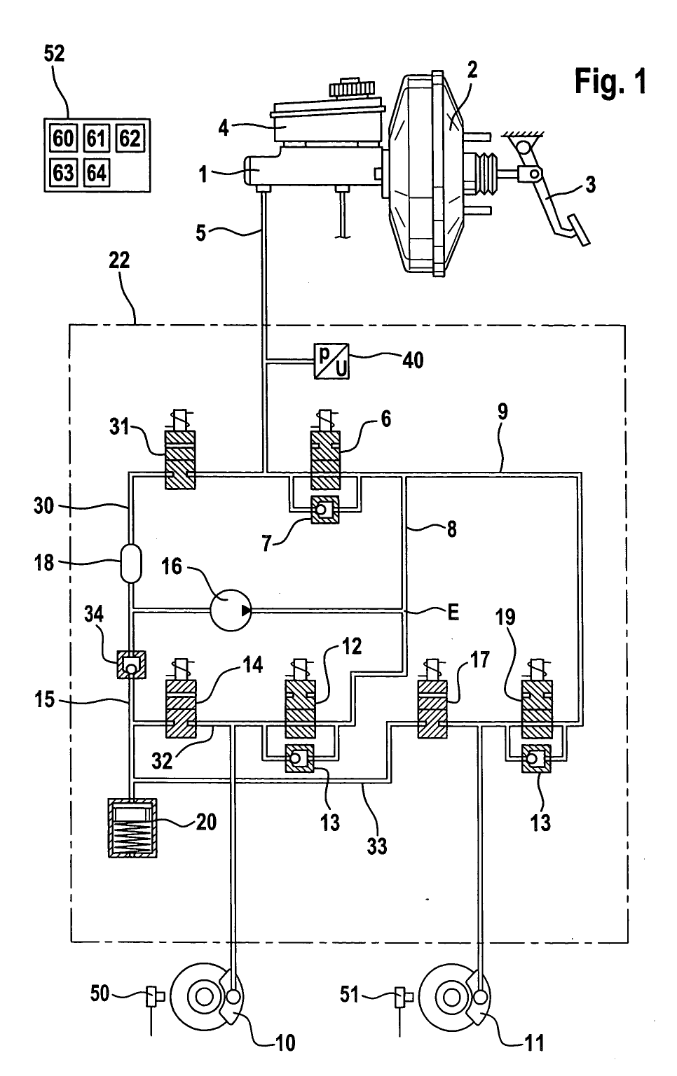

The dual-circuit brake system for motor vehicles, as illustrated in FIG. 1, is composed of an actuating unit 1, e.g. a brake cylinder, with a brake booster 2 actuated by a brake pedal 3. Arranged at the actuating unit 1 is a supply reservoir 4 that contains a pressure fluid volume and is connected to the working chamber of the actuating unit in the position of brake release. The one brake circuit illustrated comprises a brake line 5 that is connected to a working chamber of the actuating unit 1 and provides a connection between the actuating unit 1 and the one hydraulic unit 22. The brake line 5 includes a separating valve 6 providing an open passage for the brake line 5 in the inactive position of the separating valve 6. Connected in parallel to the separating valve 6 is a non-return valve 7 that opens in the direction of the wheel brakes 10, 11. The separating valve performs the function of a pressure-limiting valve. The separating valve is herein used as a pressure modulation unit. The separating valve 6 is usually actuated electromagnetically. Preferably, the separating valve is an analogized valve. In this case, a continuous, ‘analog’ adjustment of the pressure or of the pressure reduction is especially possible. Advantageously, the function of a pressure-limiting valve in an analogized valve can be realized by a corresponding control, whereby the need for purely mechanical pressure-limiting means is obviated.

The brake line 5 branches into two brake lines 8, 9 respectively leading to a wheel brake 10, 11. Brake lines 8, 9 respectively contain an electromagnetically operable inlet valve 12, 19 being open in its inactive position and adapted to assume its closed position by energization of the actuating magnet. Connected in parallel to each inlet valve 12, 19 is a non-return valve 13 opening in the direction of the brake cylinder 1. Connected in parallel to these wheel brake circuits is a so-called return delivery circuit that comprises return lines 15, 32, 33 with a pump 16. The wheel brakes 10, 11 are connected by way of each one outlet valve 14, 17 and return lines 32, 33 to the return line 15 and, hence, to the suction side of the pump 16 whose pressure side is connected to the brake pressure line 8 in a mouth E between the separating valve 6 and the inlet valves 12, 19.

Pump 16 is preferably configured as a reciprocating piston pump with a pressure valve (not shown) and a suction valve. Pump 16 is herein used as a pressure-increasing unit for generating the additional hydraulic brake force boosting. A low-pressure accumulator 20 is arranged at the suction side of the pump 16, composed of a housing (not shown) with a spring and a piston. A preloaded non-return valve 34 opening towards the pump is inserted into the connection between the low-pressure accumulator 20 and the pump 16. The suction side of pump 16 is further connected to the brake cylinder 1 by way of a suction line 30 with a low-pressure damper 18 and a change-over valve 31. Besides, the brake-force transmitting circuit includes a pressure sensor 40 that is arranged in the brake line 5 between the brake cylinder 1 or the change-over valve 31 and the separating valve 6. The brake cylinder pressure is detected and the introduced brake pressure determined by way of the pressure sensor 40. The wheel rotational speeds are determined by the wheel speed sensors 50, 51, and the signals are sent to an electronic brake control unit 52.

The brake system operates as follows:

In braking operations, the driver increases the brake fluid pressure in the system by way of the actuating unit 1 with the vacuum brake booster 2. The pressure sensor 40 determines the pressure of the brake cylinder 1 or the brake pressure introduced into the brake line 5. A first evaluating unit 60 for actuating the pump that is associated with the electronic control unit 52 is used to introduce pressure into the wheel brakes for active brake force boosting when a point of maximum boosting of a brake force booster is reached or exceeded as soon as the pressure has reached a value that describes the maximum boosting pressure of the actuating unit or the point of maximum boosting of the brake booster. The transition from pneumatic brake force boosting by way of the vacuum brake booster to active brake force boosting by way of the pump 16 is executed this way. When the brake pressure introduced into the system and the wheel brakes reaches or exceeds a value, the wheels are exposed to brake slip, and ABS control is initiated by the electronic control unit 52.

Associated with the electronic control unit 52 is a first determining unit 61 for determining a nominal pressure or a nominal vehicle acceleration corresponding to the pressure according to the pressure sensor signal, a second determining unit 62 for determining an actual vehicle acceleration or an actual pressure corresponding to the vehicle acceleration according to the wheel speed sensor signal, a comparison unit 63 for comparing the nominal pressure with the actual pressure or the actual vehicle acceleration with the nominal vehicle acceleration, a second evaluating unit 64 for actuating the pump 16 or the separating valve 6 according to the comparison. When the nominal pressure is higher than the actual pressure or when the nominal vehicle acceleration is lower than the actual vehicle acceleration, the pump 16 is actuated for the purpose of generating additional pressure, and when the nominal pressure is lower than the actual pressure or when the nominal vehicle acceleration is higher than the actual vehicle acceleration, the separating valve 6 is actuated for producing an additional pressure reduction.

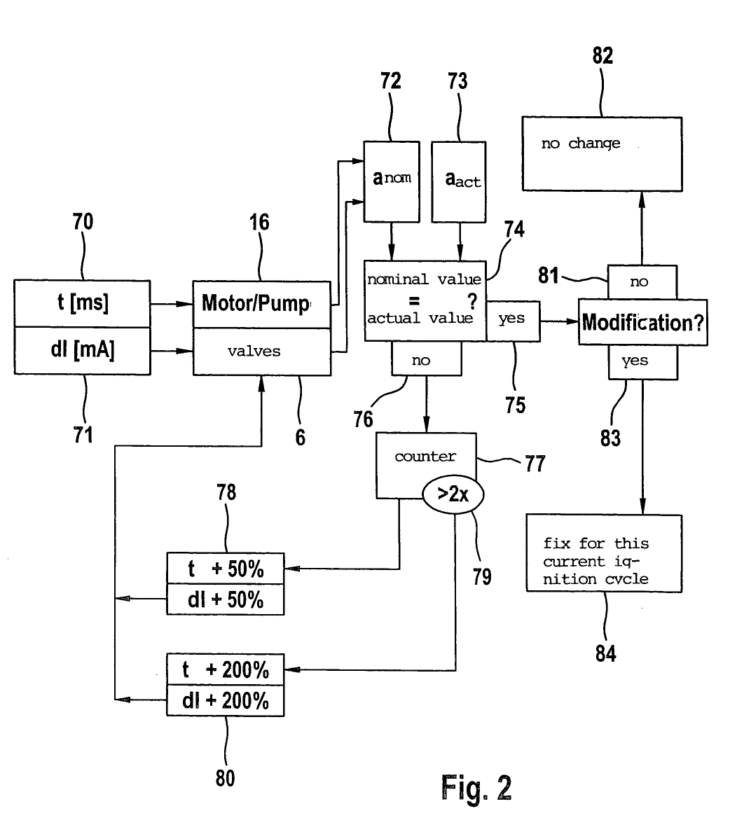

FIG. 2 schematically shows the method in a flow chart. The actuation of valve 6 with a defined current strength (d1 [mA]) 71 or the actuation of pump 16 or an electric motor driving pump 16 for a defined time (t [ms]) 70 leads to a nominal acceleration aₙₒₘ 72 which should correspond to the actual acceleration a_{actual} 73 under ‘normal’ conditions. The actual acceleration can be sensed by means of a longitudinal acceleration sensor or by monitoring a deceleration signal determined from the wheel speeds according to the wheel speed sensors 50, 51. When a coincidence was detected (step 75) in a comparison of the actual value with the nominal value in step 74 and a modified actuation did not take place previously (step 81), the original control is maintained (step 82).

The actuations 70 and 71 ensuring a desired minimum pressure increase or pressure reduction at ambient temperatures could suffer from a limited hydraulic efficiency at low or very low temperatures. Ensuing from such a ‘critical actuation’ is consequently a reduced vehicle reaction or no vehicle reaction to the request of the driver. This external influence variable of the temperature is additionally superimposed by manufacturing tolerances, wear, etc. When an actuation is detected which must be assessed as critical under the given influences, the vehicle must show a corresponding reaction to the system activity. When e.g. minimal pressure reductions are initiated by the driver, the vehicle must show a reduced deceleration after a short delay time, or even the (positive) acceleration must increase, for example, in the case of downhill driving. Thus, a (mathematical) rise of the acceleration can principally be expected. When this vehicle reaction is not detected, the actuation of the component is so modified according to the method of the invention that the throughflow increases in the direction of the preferred flow, pressure increase, or pressure reduction and is thus raised to an uncritical extent. If, accordingly, the nominal value 72 differs from the actual value 73, initially a counter 77 based on a start value is raised by one, and there will be an actuation in the direction of higher throughflow, i.e. a higher pressure increase due to actuation of pump 16 which is preferably 50% longer in a pressure increase phase or a more intensive actuation of the valve 6 (step 78) by preferably 50% in the direction of a reduced valve energization in a pressure reduction phase.

When a deviation repeats despite this correction made, the counter 77 is increased again by one. As a result, the current counter adopts a value, which is by two above the start value in this example (step 79). With the repeated deviation 76, now an actuation is executed in the direction of greater flow, i.e. a higher pressure increase by a preferably 200% longer pump actuation of the pump 16 in a pressure increase phase or a more intensive actuation of the valve 6 (step 80) by preferably 200% in the direction of a larger valve opening and, thus, a greater pressure reduction in a pressure reduction phase. This operation takes place until a sufficient concurrence between actual value and nominal value has been achieved (steps 74, 75). Once this concurrence has been achieved after modification of the actuation (step 83), this modification is first of all fixed for the current ignition cycle (step 84) because generally the conditions for the current driving of the vehicle should stay the same until interruption of the ignition. A new ignition cycle will actuate the pump 16 and the valve 6 again as originally. Counter 77 starts with its basic value. If it is necessary several times in succession, however, to modify actuation of a component 6 or 16 in such a way that the flow in the direction of the preferred throughflow increases, without the demanded vehicle reaction being detected, deactivation of the system or an alarm may also be expedient. In systems where pressure sensors monitor the hydraulic efficiency, it is possible in this method to perform an emergency function at a fallback level when a sensor fails. In this arrangement, it is preferred to monitor the vertical axle of the vehicle, preferably by a yaw rate sensor, in order to avoid skewing (in vehicles with a diagonal brake split-up). Principally, this method can also be utilized to monitor systems that support the driver in the brake pressure build-up, but have their operating range below the utilization of the coefficient of friction.

1-14. (canceled)

15. Method for controlling a vehicle brake system with active hydraulic brake force boosting,
herein an active pressure-increasing unit or a pressure modulation unit is actuated according to a comparison of a nominal pressure or a nominal vehicle speed or quantities derived therefrom, with an actual pressure or an actual vehicle speed or quantities derived therefrom.

16. Method as claimed in claim 15,
wherein when the pressure-increasing unit is actuated for brake pressure increase purposes, the nominal pressure is compared to an actual pressure or the nominal vehicle acceleration is compared to an actual vehicle acceleration, and wherein when the nominal pressure exceeds the actual pressure or when the nominal vehicle acceleration is lower than the actual vehicle acceleration, the pressure-increasing unit is actuated to generate additional pressure.

17. Method as claimed in claim 15,
the method further comprising the pressure-increasing unit is actuated for brake pressure increase purposes, the nominal pressure is compared to an actual pressure or the nominal vehicle acceleration is compared to an actual vehicle acceleration, and when the nominal pressure exceeds the actual pressure or when the nominal vehicle acceleration is lower than the actual vehicle acceleration, the pressure-increasing unit is actuated to generate additional pressure,
wherein the pressure-increasing unit is actuated to produce an additional pressure when the nominal pressure is higher than the actual pressure or the nominal vehicle acceleration is lower than the actual vehicle acceleration for a predetermined period of time.

18. Method as claimed in claim 15,
wherein in order to produce additional pressure or to produce an additional negative vehicle acceleration, the pressure-increasing unit extends the pump actuation time by 30% to 100%, with respect to the original pump actuation time when the nominal pressure is higher than the actual pressure or the nominal vehicle acceleration is lower than the actual vehicle acceleration.

19. Method as claimed in claim 15,
wherein the pressure-increasing unit is actuated to generate additional pressure when the nominal pressure is higher than the actual pressure by at least 20% to 50%, with respect to the nominal pressure, or when the nominal vehicle acceleration is lower than the actual vehicle acceleration by at least 40% to 60%, with respect to the nominal vehicle acceleration.

20. Method as claimed in claim 15,
wherein the pressure-increasing unit for producing an additional pressure or for producing an additional negative vehicle acceleration extends the pump actuation time by 200% to 400%, with respect to the original pump actuation time when the condition that the nominal pressure is higher than the actual pressure or the nominal vehicle acceleration is lower than the actual vehicle acceleration was detected several times in succession.

21. Method as claimed in claim 15,
wherein when the pressure modulation unit, like an hydraulic valve, is actuated to produce an additional pressure reduction, the nominal pressure is compared with an actual pressure or the nominal vehicle acceleration is compared with an actual vehicle acceleration, and wherein the pressure modulation unit is actuated to produce an additional pressure when the nominal pressure is lower than the actual pressure or when the nominal vehicle acceleration is higher than the actual vehicle acceleration.

22. Method as claimed in claim 15,
the method further comprising when the pressure modulation unit, like an hydraulic valve, is actuated to produce an additional pressure reduction, the nominal pressure is compared with an actual pressure or the nominal vehicle acceleration is compared with an actual vehicle acceleration, and the pressure modulation unit is actuated to produce an additional pressure when the nominal pressure is lower than the actual pressure or when the nominal vehicle acceleration is higher than the actual vehicle acceleration,
wherein the pressure modulation unit is actuated to produce an additional pressure reduction when the nominal pressure is lower than the actual pressure or the nominal vehicle acceleration is higher than the actual vehicle acceleration for a predefined period of time.

23. Method as claimed in claim 15,
wherein the pressure modulation unit, like an hydraulic valve, increases the valve actuation current strength by 30% to 100%, with respect to the original valve actuation current strength for producing an additional pressure reduction when the nominal pressure is lower than the actual pressure or when the nominal vehicle acceleration is higher than the actual vehicle acceleration

24. Method as claimed in claim 15,
wherein the pressure modulation unit, like an hydraulic valve, is actuated to produce an additional pressure reduction, when the nominal pressure is lower than the actual pressure by at least 20% to 50%, or when the nominal vehicle acceleration is higher than the actual vehicle acceleration by at least 40% to 60%, with respect to the nominal vehicle acceleration.

25. Method as claimed in claim 15,
wherein the pressure modulation unit, like an hydraulic valve, increases the valve actuation current strength by 200% to 400%, with respect to the original valve actuation current strength for producing an additional pressure reduction when the condition that the nominal pressure is lower than the actual pressure or the nominal vehicle acceleration is higher than the actual vehicle acceleration was detected several times in succession.

26. Method as claimed in claim 15,
wherein a modified actuation of the pressure-generating unit or the pressure modulation unit is memorized for an ignition cycle, that means until the ignition of the vehicle is switched off.

27. Method as claimed in claim 15,
wherein the method is a program or part of a program of a control and regulating program of a vehicle brake system, and wherein modifications of the actuation of the pressure-generating unit or the pressure modulation unit will not take place until three to ten program runs have been executed or upon expiry of a period of 50 to 100 msec or when at least five to ten actuations of the pump or the valve have already been executed.

28. Device for controlling a vehicle brake system with active hydraulic brake force boosting, including an actuating unit by means of which the driver can introduce brake pressure into a hydraulic unit, with at least one wheel brake that is connected to the actuating unit by way of the hydraulic unit containing at least one brake line, with a pump communicating with its suction side with the actuating unit by way of a change-over valve and communicating with its pressure side with the brake line, with an actuatable inlet valve arranged in the brake line, with an actuatable separating valve interposed between the inlet valve and the actuating unit, with an actuatable outlet valve arranged in a return line, with a pressure sensor associated with the actuating unit, with a wheel speed sensor and with a first actuating unit for actuating the pump that introduces pressure into the wheel brakes for active brake force boosting when a point of maximum boosting of the brake booster is reached or exceeded,
wherein a first determining unit for determining a nominal pressure or a nominal vehicle acceleration that corresponds to the pressure according to the pressure sensor signal, a second determining unit for determining an actual vehicle acceleration or an actual pressure that corresponds to the vehicle acceleration according to the wheel speed sensor signal, a comparison unit for comparing the nominal pressure with the actual pressure or the actual vehicle acceleration with the nominal vehicle acceleration, a second evaluating unit for actuating the pump or the separating valve according to the comparison, and wherein when the nominal pressure is higher than the actual pressure or when the nominal vehicle acceleration is lower than the actual vehicle acceleration, the pump is actuated for the purpose of generating additional pressure, and when the nominal pressure is lower than the actual pressure or when the nominal vehicle acceleration is higher than the actual vehicle acceleration, the separating valve is actuated for producing an additional pressure reduction.
